(19) United States
(12) Patent Application Publication
(10) Pub. No.: US 2014/0149462 A1
(43) Pub. Date: May 29, 2014

(54) PROCESSING OF COLUMNAR DATA

(71) Applicants: Roman Moehl, Bad Schonborn (DE); Stefan Dipper, Wiesloch (DE)

(72) Inventors: Roman Moehl, Bad Schonborn (DE); Stefan Dipper, Wiesloch (DE)

(21) Appl. No.: 13/687,348

(22) Filed: Nov. 28, 2012

(51) Int. Cl. G06F 17/30

(52) U.S. Cl. CPC G06F 17/30315
USPC 707/792

(57) ABSTRACT

A system includes reception of a calculation, identification of operands of the calculation, and a source column of a table including values associated with the operands and used in the calculation, creation, for each operand, creation of a column including the value associated with that operand in a row of the column associated with that operand, column-wise aggregation of the values of the created columns into a single row, execution of the calculation using the values of the single row and create a result column including a result of the calculation, and addition of the result column as a row of the table.

### BACKGROUND

A typical relational database system is capable of calculating a formula specified by a single relational statement (e.g., a Structured Query Language statement). However, relational algebra can only express formulas in which each formula operand is located in a same table row. For example, SQL distinguishes between AGGREGATION, an operation on one single column that involves all rows (e.g., SUM, MIN, MAX, AVG . . . ), and CALCULATION, an operation on a row that can involve all columns, but can only involve values within the same row. Therefore, a single relational statement may be used to perform an aggregation operation on values located in disparate rows of a same table column, but cannot be used to perform a calculation in which two or more formula operands are located in different table rows.

### BRIEF DESCRIPTION OF THE DRAWINGS

FIG. 1 is a block diagram of a system according to some embodiments.

FIG. 2 is a flow diagram of a process according to some embodiments.

FIG. 3 is a tabular representation of a portion of a database table according to some embodiments.

FIG. 4 is a tabular representation of a portion of a database table according to some embodiments.

FIG. 5 is a tabular representation of a table according to some embodiments.

FIG. 6 is a tabular representation of a table according to some embodiments.

FIG. 7 is a tabular representation of a table according to some embodiments.

FIG. 8 is a block diagram of a system according to some embodiments.

FIG. 9 is a block diagram of an apparatus according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

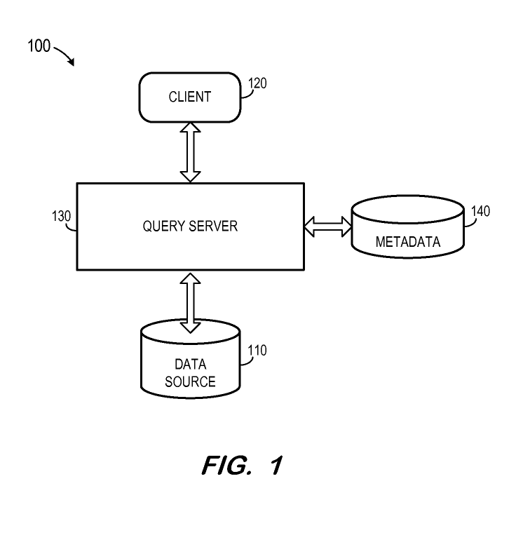

FIG. 1 is a block diagram of system 100 according to some embodiments. System 100 includes data source 110, client 120, and query server 130. Data source 110 may comprise any query-responsive data source or sources that are or become known, including but not limited to a structured-query language (SQL) relational database management system. Data source 110 may comprise a relational database, a multi-dimensional database, an eXtendable Markup Language (XML) document, or any other data storage system storing structured and/or unstructured data. The data of data source 110 may be distributed among several relational databases, dimensional databases, and/or other data sources. Embodiments are not limited to any number or types of data sources. For example, data source 110 may comprise one or more OnLine Analytical Processing (OLAP) databases, spreadsheets, text documents, presentations, etc.

In some embodiments, data source 110 is implemented in Random Access Memory (e.g., cache memory for storing recently-used data) and one or more fixed disks (e.g., persistent memory for storing their respective portions of the full database). Alternatively, data source 110 may implement an “in-memory” database, in which volatile (e.g., non-disk-based) memory (e.g., Random Access Memory) is used both for cache memory and for storing its entire respective portion of the full database. In some embodiments, the data of data source 110 may comprise one or more of conventional tabular data, row-based data, column-based data, and object-based data. Data source 110 may also or alternatively support multi-tenancy by providing multiple logical database systems which are programmatically isolated from one another. Moreover, the data of data source 110 may be indexed and/or selectively replicated in an index to allow fast searching and retrieval thereof.

Query server 130 generally provides data of data source 110 to reporting clients such as client 120. The data may be provided based on metadata 140, which provides information regarding the structure, relationships and meaning of the data of data source 110.

In some embodiments, metadata 140 describes database tables of data source 110. The descriptions may include table names, technical names and data types of each table column, and column names.

Client 120 may comprise one or more devices executing program code of a software application for presenting user interfaces to allow interaction with query server 130. Presentation of a user interface may comprise any degree or type of rendering, depending on the type of user interface code generated by query server 130. For example, client 120 may execute a Web Browser to receive a Web page (e.g., in HTML format) from query server 130, and may render and present the Web page according to known protocols. Client 120 may also or alternatively present user interfaces by executing a standalone executable file (e.g., an .exe file) or code (e.g., a JAVA applet) within a virtual machine.

According to some embodiments, client 120 may generate MultiDimensional eXpressions (MDX) statements based on user interaction with its user interfaces. Such a client 120 may comprise an “analysis client” typically used to execute calculations upon stored multi-dimensional data and to view the results of such calculations. Client 120 may also or alternatively generate SQL statements based on received user interactions. SQL-based clients are typically used to access and view stored relational (i.e., “tabular”) data. As will be described below, client 120 may generate MDX statements to execute calculations upon relational data stored in data source 110. System 100 may include any number of clients 120 of one or more types according to some embodiments.

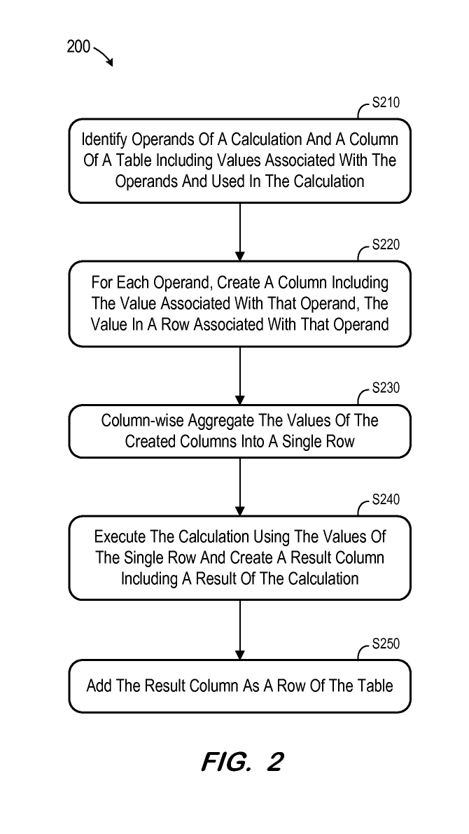

FIG. 2 comprises a flow diagram of process 200 according to some embodiments. In some embodiments, various hardware elements of query server 130 execute program code to perform process 200. Process 200 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

A calculation is received prior to process 200. The calculation may be received from client 120 by query server 130. The calculation includes two or more operands, with each operand being associated with a row of a table and a value.

For purposes of providing an example of process 200 according to some embodiments, it will be assumed that a calculation is received prior to process 200 in the form of the following MDX statement received from client 120:

WITH
MEMBER [CALYEAR].[Diff 2003/2002] AS [CALYEAR].[2003] −
[CALYEAR].[2002]
SELECT
{ [Measures].[SOLD_QUANTITY] } ON COLUMNS,
NON EMPTY
{ [CALYEAR].[2003], [CALYEAR].[2002], [CALYEAR].[Diff
2003/2002] }
ON ROWS
FROM [Sales]

The above MDX statement is intended to generate a “calculated member”, which is a “new” table row including values derived by formula from values located in other rows.

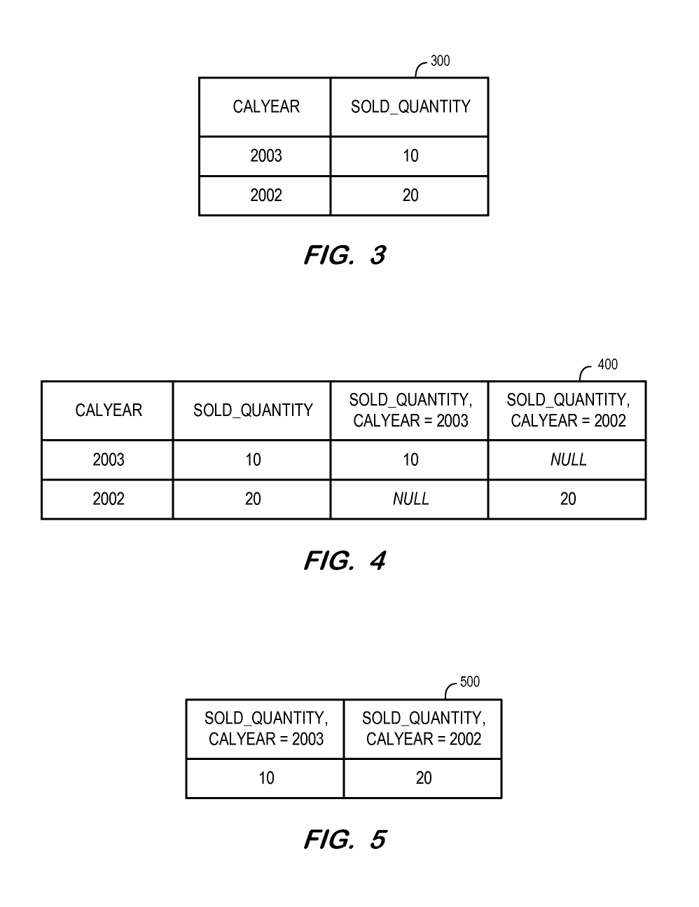

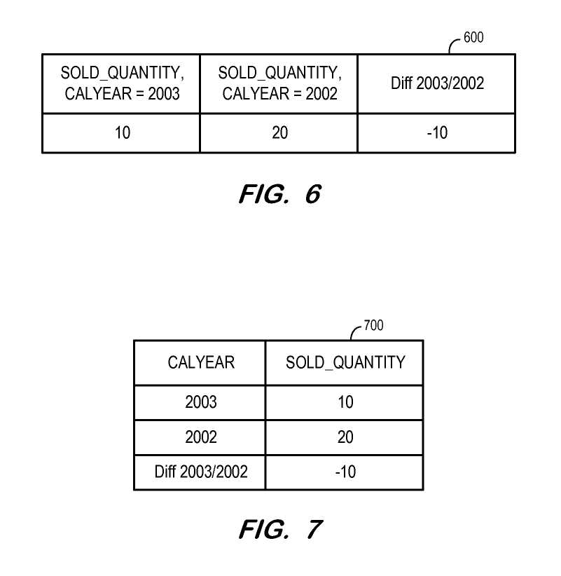

FIG. 3 is a tabular representation of Sales database table 300 referenced in the above MDX statement. It may be assumed that table 300 is stored and managed by a relational database management system of data source 110.

Table 300 includes two columns, CALYEAR and SOLD_QUANTITY. Each column includes two rows and a value is associated with each row. The above MDX statement is intended to calculate the difference “Diff 2003/2002” between the number of sold entities (SOLD_QUANTITY) of year 2003 (CALYEAR=2003) and year 2002 (CALYEAR=2002). Stated symbolically, Diff 2003/2002=(SOLD_QUANTITY, CALYEAR=2003)−(SOLD_Quantity, CALYEAR=2002). This calculation is performed within a column (SOLD_QUANTITY), in that the values used in the calculation (10, 20) are located in different rows of the column. Accordingly, this calculation cannot be expressed in a single relational statement.

Accordingly, process 200 begins at S210, in which operands of the calculation are identified. Also identified at S210 is a column of the table including values associated with the operands and used in the calculation. In the present example, the operands are CALYEAR_{—}2003 and CALYEAR_{—}2002, and the column is SOLD_QUANTITY.

Next, at S220, a column is created for each operand. Each created column includes the value associated with its operand, in a row associated with the operand. Table 400 of FIG. 4 illustrates the execution of S220 according to the present example. As shown, the column SOLD_QUANTITY, CALYEAR=2003 was created for the operand CALYEAR, 2003. This column includes the value (i.e., 10) which is associated with its operand (i.e., CALYEAR, 2003) in the identified column (i.e., SOLD_QUANTITY), in a row of the newly-created column which is associated with the operand.

Similarly, the column SOLD_QUANTITY, CALYEAR=2002 was created for the operand CALYEAR, 2002. This column includes the value (i.e., 20) which is associated with its operand (i.e., CALYEAR, 2002) in the identified column (i.e., SOLD_QUANTITY), in a row of the newly-created column which is associated with the operand. The remaining rows of the newly-created columns are not populated.

Table 400 may simply comprise a logical structure to illustrate the intermediate states of process 200. That is, table 400 need not be instantiated at any time during process 200. If it were to be instantiated, the selections reflected therein could be expressed by the following SQL statement:

SELECT CALYEAR, SUM(SOLD_QUANTITY) AS
SOLD_QUANTITY,

CASE WHEN CALYEAR = ‘2003’ THEN SUM(
SOLD_QUANTITY) ELSE NULL END AS

SOLD_QUANTITY_2003,

CASE WHEN CALYEAR = ‘2002’ THEN SUM(
SOLD_QUANTITY) ELSE NULL END AS

SOLD_QUANTITY_2002 FROM(
SELECT CALYEAR, SUM(SOLD_QUANTITY) AS
SOLD_QUANTITY FROM “Sales” GROUP BY
CALYEAR
) GROUP BY CALYEAR

According to some embodiments, query server 130 supports restricted key figures, and therefore the selection of S220 could be logically visualized in an SQL-like notation as follows:

SELECT CALYEAR, SUM(SOLD_QUANTITY) AS
SOLD_QUANTITY, SUM(SOLD_QUANTITY) WHERE
CALYEAR = 2003 AS SOLD_QUANTITY_2003,
SUM(SOLD_QUANTITY_2002) WHERE CALYEAR =
2003 AS SOLD_QUANTITY_2002 FROM (
SELECT CALYEAR, SUM(SOLD_QUANTITY) FROM “Sales”
GROUPBY CALYEAR
) GROUP BY CALYEAR

Next, at S230, the created columns are column-wise aggregated into a single row in order to have the values of all calculation operands in a single row. In the example above, the following columns remain after S230:

SOLD_QUANTITY, CALYEAR=2003

SOLD_QUANTITY, CALYEAR=2002

Only a single row remains after aggregation, because the aggregation of a value and NULL results in a single value (value+NULL=value). FIG. 5 illustrates aggregated table 500 after some embodiments of S230. Again, table 500 is not necessarily instantiated in memory; it is intended to illustrate the logical operations of process 200 according to some embodiments.

Next, at S240, the calculation is executed using the values of the single row and a result column is created. The result column includes a result of the calculation. As mentioned above, location of the values in a single row facilitates the generation and execution of a single SQL statement which expresses the calculation.

Since it is known that the aggregation at S230 will result in a single row, the aggregation and the calculation at S240 may be executed simultaneously. The following SQL statement may be used in some embodiments to implement this functionality:

SELECT ‘DIFF_2003/2002’ AS CALYEAR,

SUM( SOLD_QUANTITY_2003 ) AS SOLD_QUANTITY_2003,
SUM( SOLD_QUANTITY_2002 ) AS SOLD_QUANTITY_2002,
SUM( SOLD_QUANTITY_2003 ) − SUM(
SOLD_QUANTITY_2002 ) AS SOLD_QUANTITY

FROM(SELECT CALYEAR, SUM(SOLD_QUANTITY) AS
SOLD_QUANTITY,
CASE WHEN CALYEAR = ‘2003’ THEN SUM( SOLD_QUANTITY)
ELSE NULL END AS
SOLD_QUANTITY_2003,
CASE WHEN CALYEAR = ‘2002’ THEN SUM( SOLD_QUANTITY)
ELSE NULL END AS
SOLD_QUANTITY_2002 FROM(
SELECT CALYEAR, SUM(SOLD_QUANTITY) AS
SOLD_QUANTITY FROM “Sales” GROUP BY
CALYEAR
) GROUP BY CALYEAR
)

The first SQL statement presented herein is nested in the above SQL statement. Accordingly, the above SQL statement represents execution of S220-S240 of process 200.

In the case of a query server supporting restricted key figures, the following SQL-like notation may visualize S220-S240:

SELECT “DIFF_2003/2002” AS CALYEAR,

SUM(SOLD_QUANTITY_2003) AS SOLD_QUANTITY_2003,
SUM(SOLD_QUANTITY_2002) AS SOLD_QUANTITY_2002,
SUM(SOLD_QUANTITY_2003) −
SUM(SOLD_QUANTITY_2002) AS DIFF_2003_2002

FROM (
SELECT CALYEAR, SUM(SOLD_QUANTITY) AS
SOLD_QUANTITY, SUM(SOLD_QUANTITY)

WHERE CALYEAR = 2003 AS SOLD_QUANTITY_2003,
SUM(SOLD_QUANTITY_2002)
WHERE CALYEAR = 2003 AS SOLD_QUANTITY_2002 FROM
(

SELECT CALYEAR, SUM(SOLD_QUANTITY) FROM “Sales”
GROUPBY CALYEAR
) GROUP BY CALYEAR
) GROUP BY CALYEAR

The result column is added as a row to the original table at S250. Table 700 illustrates this addition and represents the final result set. A constant value “Diff 2003/2002” has been added to fill the new row of column CALYEAR.

According to some embodiments, the result column is added at S250 by adding the relation of S240 (i.e., table 600) to the initial relation (i.e., table 300) using a UNION operation.

A suitable SQL statement for this union follows, which nests the first and third SQL statements set forth above:

SELECT CALYEAR, SUM(SOLD_QUANTITY) AS
SOLD_QUANTITY FROM “Sales” GROUP BY
CALYEAR
UNION ALL
SELECT ‘DIFF_2003/2002’ AS CALYEAR,

SUM( SOLD_QUANTITY_2003 ) AS SOLD_QUANTITY_2003,
SUM( SOLD_QUANTITY_2002 ) AS SOLD_QUANTITY_2002,
SUM( SOLD_QUANTITY_2003 ) − SUM(
SOLD_QUANTITY_2002 ) AS SOLD_QUANTITY

FROM(SELECT CALYEAR, SUM(SOLD_QUANTITY) AS
SOLD_QUANTITY,
CASE WHEN CALYEAR = ‘2003’ THEN SUM( SOLD_QUANTITY)
ELSE NULL END AS
SOLD_QUANTITY_2003,
CASE WHEN CALYEAR = ‘2002’ THEN SUM( SOLD_QUANTITY)
ELSE NULL END AS
SOLD_QUANTITY_2002 FROM(
SELECT CALYEAR, SUM(SOLD_QUANTITY) AS
SOLD_QUANTITY FROM “Sales” GROUP BY
CALYEAR
) GROUP BY CALYEAR
)
) GROUP BY CALYEAR

Accordingly, the above SQL statement may implement S220-S250 in some embodiments.

Similarly, the following notation may visualize S220-S250 in conjunction with a query server supporting restricted key figures.

SELECT CALYEAR, SUM(SOLD_QUANTITY) AS
SOLD_QUANTITY FROM “Sales” GROUPBY
CALYEAR
UNION ALL
SELECT CALYEAR, SUM (SOLD_QUANTITY) FROM (
SELECT “DIFF_2003/2002” AS CALYEAR,

SUM(SOLD_QUANTITY_2003) AS SOLD_QUANTITY_2003,
SUM(SOLD_QUANTITY_2002) AS SOLD_QUANTITY_2002,
SUM(SOLD_QUANTITY_2003) −
SUM(SOLD_QUANTITY_2002) AS DIFF_2003_2002

FROM (
SELECT CALYEAR, SUM(SOLD_QUANTITY) AS
SOLD_QUANTITY, SUM(SOLD_QUANTITY)

WHERE CALYEAR = 2003 AS SOLD_QUANTITY_2003,
SUM(SOLD_QUANTITY_2002)
WHERE CALYEAR = 2003 AS SOLD_QUANTITY_2002 FROM
(

SELECT CALYEAR, SUM(SOLD_QUANTITY) FROM “Sales”
GROUPBY CALYEAR
) GROUP BY CALYEAR
) GROUP BY CALYEAR
) GROUP BY CALYEAR

The above calculation is merely an example, and some embodiments may support any calculations in which operand values are located in disparate table rows.

According to some embodiments, query server 130 generates an execution plan based on the above SQL statements, as is known in the art, and passes the plan to data source 110 to generate the requested relation.

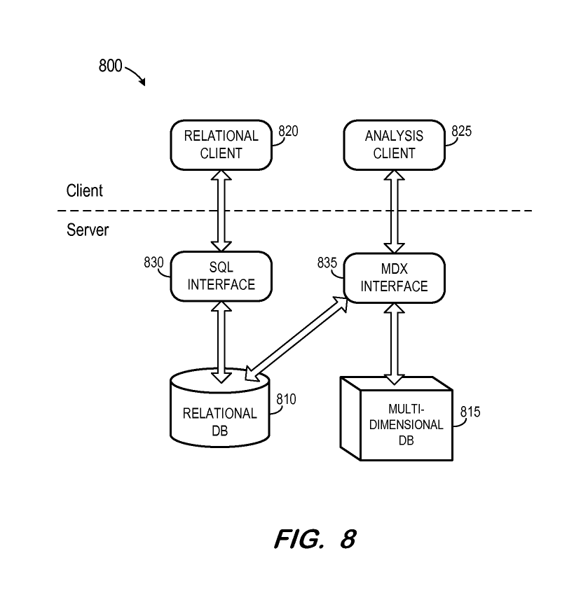

FIG. 8 is a block diagram of a system according to some embodiments. System 800 may comprise an implementation of system 100 of FIG. 1, in which client 120 is implemented by relational client 820 and analysis client 825. Query server 130 is represented by SQL interface 830 and MDX interface 835, and data source 110 comprises relational database 810 and multidimensional database 815.

MDX interface 835 typically receives MDX statements from analysis client 825, which may specify calculations upon multi-dimensional data stored in multi-dimensional database 815, and interacts with multi-dimensional database 815 to provide corresponding data to MDX client 825. SQL interface 830, on the other hand, receives SQL statements from relational client 820 and retrieves corresponding data from relational database 810.

According to some embodiments, and as illustrated in FIG. 8, MDX interface 835 may also retrieve data from relational database 810 based on MDX statements received from analysis client 825. For example, MDX interface 835 may receive a “calculated members” MDX statement to run against relational tables of relational database 810. The calculation specified by this statement may include operands located in different table rows. Accordingly, MDX interface 835 may operate to generate an execution plan as described with respect to process 200, and pass the execution plan to relational database 810 in order to generate the requested relation.

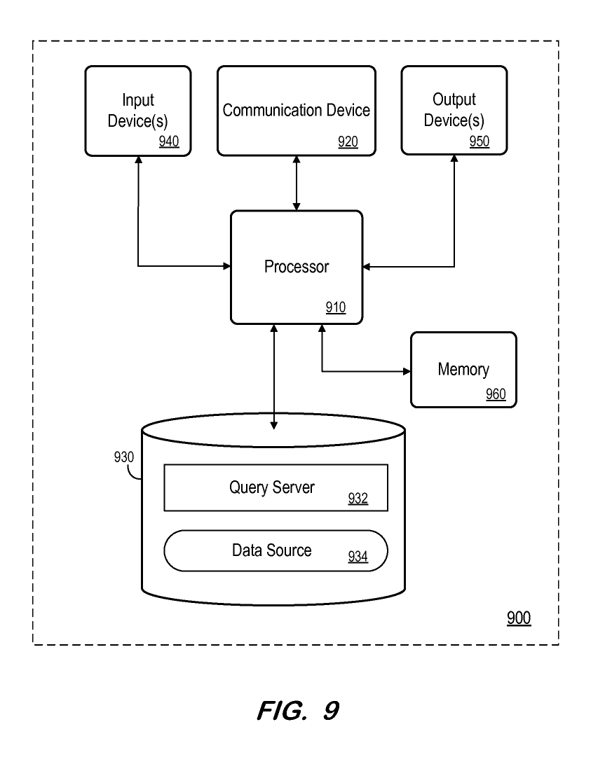

FIG. 9 is a block diagram of apparatus 900 according to some embodiments. Apparatus 900 may comprise a general-purpose computing apparatus and may execute program code to perform any of the functions described herein. Apparatus 900 may comprise an implementation of query server 130 and data source 110, or of the entirety of system 100. Apparatus 900 may include other unshown elements according to some embodiments.

Apparatus 900 includes processor 910 operatively coupled to communication device 920, data storage device 930, one or more input devices 940, one or more output devices 950 and memory 960. Communication device 920 may facilitate communication with external devices, such as a reporting client, or a data storage device. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into apparatus 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, etc., while memory 960 may comprise Random Access Memory (RAM).

Query server 932 may comprise program code executed by processor 910 to cause apparatus 900 to perform any one or more of the processes described herein. Embodiments are not limited to execution of these processes by a single apparatus. Data source 934 may implement data source 110 as described above. As also described above, data source 110 may be implemented in volatile memory such as memory 960. Data storage device 930 may also store data and other program code for providing additional functionality and/or which are necessary for operation of apparatus 900, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a data storage device storing a table comprising rows;
a computing device comprising:
a memory storing processor-executable program code; and
a processor to execute the processor-executable program code in order to cause the computing device to:
receive a calculation;
identify operands of the calculation, and a source column of a table including values associated with the operands and used in the calculation;
for each operand, create a column including the value associated with that operand in a row of the column associated with that operand;
column-wise aggregate the values of the created columns into a single row;
execute the calculation using the values of the single row and create a result column including a result of the calculation; and
add the result column as a row of the table.

2. A system according to claim 1, wherein receipt of the calculation comprises receipt of a MultiDimensional eXpressions query.

3. A system according to claim 1, wherein the creation of the columns, aggregation of the values, and execution of the calculation comprise generation of an execution plan.

4. A system according to claim 3, the processor to further execute the processor-executable program code in order to cause the computing device to transmit the execution plan to a relational database system.

5. A system according to claim 4, the processor to further execute the processor-executable program code in order to cause the computing device to receive the result of the calculation from the relational database system.

6. A system according to claim 1, wherein the identified operands are located in different respective rows of the table.

7. A non-transitory computer-readable medium storing program code, the program code executable by a processor of a computing system to cause the computing system to:
receive a calculation;
identify operands of the calculation, and a source column of a table including values associated with the operands and used in the calculation;
for each operand, create a column including the value associated with that operand in a row of the column associated with that operand;
column-wise aggregate the values of the created columns into a single row;
execute the calculation using the values of the single row and create a result column including a result of the calculation; and
add the result column as a row of the table.

8. A medium according to claim 7, wherein receipt of the calculation comprises receipt of a MultiDimensional eXpressions query.

9. A medium according to claim 7, wherein the creation of the columns, aggregation of the values, and execution of the calculation comprise generation of an execution plan.

10. A medium according to claim 9, the program code further executable by the processor of the computing system to cause the computing system to transmit the execution plan to a relational database system.

11. A medium according to claim 10, the program code further executable by the processor of the computing system to cause the computing system to receive the result of the calculation from the relational database system.

12. A medium according to claim 7, wherein the identified operands are located in different respective rows of the table.

13. A computer-implemented method comprising:
receiving a calculation;
identifying operands of the calculation, and a source column of a table including values associated with the operands and used in the calculation;
for each operand, creating a column including the value associated with that operand in a row of the column associated with that operand;
column-wise aggregating the values of the created columns into a single row;
executing the calculation using the values of the single row and create a result column including a result of the calculation; and
adding the result column as a row of the table.

14. A method according to claim 13, wherein receipt of the calculation comprises receipt of a MultiDimensional eXpressions query.

15. A method according to claim 13, wherein the creation of the columns, aggregation of the values, and execution of the calculation comprise generation of an execution plan.

16. A method according to claim 15, further comprising:
transmitting the execution plan to a relational database system.

17. A method according to claim 16, further comprising:
receiving the result of the calculation from the relational database system.

18. A method according to claim 13, wherein the identified operands are located in different respective rows of the table.
